(19) United States
(12) Patent Application Publication
(10) Pub. No.: US 2011/0170623 A1
(43) Pub. Date: Jul. 14, 2011

(54) APPARATUS AND METHOD FOR CHANNEL INFORMATION FEEDBACK, BASE STATION RECEIVING THE CHANNEL INFORMATION, AND COMMUNICATION METHOD OF THE BASE STATION

(75) Inventors: Kyoung-min PARK, Goyang-si (KR); Jianjun LI, Seoul (KR); Sung-jin SUH, Seoul (KR); Sungkwon HONG, Seoul (KR)

(73) Assignee: PANTECH CO., LTD., Seoul (KR)

(21) Appl. No.: 13/004,447

(22) Filed: Jan. 11, 2011

(30) Foreign Application Priority Data
Jan. 12, 2010 (KR) 10-2010-0002800

(51) Int. Cl. H04L 27/28

(52) U.S. Cl. 375/260

(57) ABSTRACT

Disclosed is a wireless communication system including an apparatus and a method for feeding back channel information of a User Equipment (UE); a Base Station (BS) for receiving channel information of a UE and for communicating with the UE; and a communication method of the BS which can dynamically switch between Single-User Multiple-Input Multiple-Output (SU-MIMO) and Multiple-User Multiple-Input Multiple-Output (MU-MIMO) access schemes.

### CROSS-REFERENCE TO RELATED APPLICATION

This application claims priority from and the benefit under 35 U.S.C. §119(a) of Korean Patent Application No. 10-2010-0002800, filed on Jan. 12, 2010, which is hereby incorporated by reference for all purposes as if fully set forth herein.

### BACKGROUND

1. Field

Embodiments of the present invention relate to a wireless communication system including an apparatus and a method for feeding back channel information of a User Equipment (UE), a Base Station (BS) for receiving channel information of a UE and for communicating with the UE, and a communication method of the BS.

2. Discussion of the Background

With the development of communication systems, a wide variety of wireless terminals are being used by consumers, such as business companies and individuals.

Current mobile communication systems, such as 3GPP (3rd Generation Partnership Project), LTE (Long Term Evolution), and LTE-A (LTE Advanced), are resulting in the development of technology for a high-speed large-capacity communication system, which can transmit or receive various data, such as images and wireless data, beyond the capability of mainly providing a voice service, and can transmit data of such a large capacity as that transmitted in a wired communication network. Moreover, the current mobile communication systems are inevitably requiring a proper error detection scheme, which can minimize the reduction of information loss and improve the system transmission efficiency, thereby improving the system performance.

Meanwhile, communication systems, each employing a MIMO (Multiple Input Multiple Output) antenna at both an input port and an output port thereof, are now being widely used. Such a communication system has a configuration, in which a Single UE (SU) or Multiple UEs (MU) transmit or receive a signal to or from a single Base Station (BS).

A system using a MIMO antenna requires a process of detecting channel states by using various reference signals and feeding back the detected channel states to a transmitting node (e.g., another apparatus).

In other words, if multiple physical channels have been allocated to a single UE, the UE can adaptively optimize the system by feeding back the channel state information of each physical channel to a BS. To this end, signals including CSI-RS (Channel Status Index-Reference Signal), CQI (Channel Quality Indicator), and PMI (Precoding Matrix Index) may be used, and the BS schedules the channels by using such channel state-related information.

### SUMMARY

Additional features of the invention will be set forth in the description which follows, and in part will be apparent from the description, or may be learned by practice of the invention.

An exemplary embodiment of the present invention provides an apparatus to feed back channel information in a wireless communication system, the apparatus including: a reference signal reception unit to receive a reference signal from a base station; a channel estimator to perform channel estimation by using the received reference signal; a precoder search unit to generate at least one type of channel information from among high resolution channel information and low resolution channel information based on a result of the channel estimation by the channel estimator; and a feedback unit to feed back the channel information, wherein the high resolution channel information corresponds to channel information indexed or expressed by larger quantity of bits than low resolution channel information and the low resolution channel information corresponds to channel information indexed or expressed by less quantity of bits than high resolution channel information.

An exemplary embodiment of the present invention provides a method for feeding back channel information in a wireless communication system, the method including: receiving a reference signal from a base station; performing channel estimation by using the received reference signal; generating at least one type of channel information from among high resolution channel information and low resolution channel information based on a result of the channel estimation; and feeding back the channel information, wherein the high resolution channel information corresponds to channel information indexed or expressed by larger quantity of bits than low resolution channel information and the low resolution channel information corresponds to channel information indexed or expressed by less quantity of bits than high resolution channel information.

An exemplary embodiment of the present invention provides a base station of a wireless communication system, the base station comprising: a layer mapper to map a codeword to a layer; a precoder to precode mapped symbols by using a precoding matrix generated based on one of high resolution channel information and low resolution channel information fed back from a User Equipment (UE); and an antenna array including at least two antennas to transmit the precoded symbols, wherein the high resolution channel information corresponds to channel indexed or expressed by larger quantity of bits than low resolution channel information and the low resolution channel information corresponds to channel information indexed or expressed by less quantity of bits than high resolution channel information.

An exemplary embodiment of the present invention provides a method for a base station in a wireless communication system, the method including: mapping a codeword to a layer; precoding mapped symbols by using a precoding matrix generated based on one of high resolution channel information and low resolution channel information fed back from a User Equipment (UE); and transmitting the precoded symbols, wherein the high resolution channel information corresponds to channel information indexed or expressed by larger quantity of bits than low resolution channel information and the low resolution channel information corresponds to channel indexed or expressed by less quantity of bits than high resolution channel information.

An exemplary embodiment of the present invention provides an apparatus to feed back channel information in a wireless communication system, the apparatus including: a reference signal reception unit to receive a reference signal; a channel estimation unit to estimate a channel by using the received reference signal; a channel state information generation unit to generate relevant channel state information based on the result of the channel estimation; and a feedback unit to feed back the relevant channel state information.

An exemplary embodiment of the present invention provides an apparatus to dynamically switch between Single-User Multiple-Input Multiple-Output (SU-MIMO) and Multiple-User Multiple-Input Multiple-Output (MU-MIMO) access schemes in a wireless communication system, the apparatus including: an SU-MIMO precoder generation unit to receive at least one of high resolution channel information and low resolution channel information and to generate a first precoder matrix; an MU-MIMO precoder generation unit to receive at least one of a high resolution index vector and a low resolution index vector and to generate a second precoder matrix; a first performance prediction unit to receive the first precoder matrix and a channel quality indicator (CQI) value; and a second performance prediction unit to receive the second precoder matrix and the CQI, wherein the first performance prediction unit and the second performance prediction unit compare performances of the first precoder matrix and the second precoder matrix to determine whether to switch between the SU-MIMO access scheme and the MU-MIMO access scheme.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates a wireless communication system according to an exemplary embodiment of the present invention.

FIG. 2 is a block diagram illustrating a channel information feedback apparatus according to an exemplary embodiment in a MIMO system.

FIG. 3 is a flowchart illustrating determining phase values of elements having specific magnitudes and different phases as each eigenvector by a channel state information generation unit as illustrated in FIG. 2 according to an exemplary embodiment.

FIG. 4 is a flowchart illustrating determining phase values of elements having specific magnitudes and different phases as each eigenvector by the channel state information generation unit as illustrated in FIG. 2.

FIG. 5 is a flowchart showing a channel information feedback method according to an exemplary embodiment in the MIMO system.

FIG. 6 is a block diagram illustrating a BS according to an exemplary embodiment.

FIG. 7 is a block diagram illustrating a channel information feedback apparatus according to an exemplary embodiment in a wireless communication system.

FIG. 8 is a flowchart showing a method for generating a high-resolution vector index and a low-resolution vector index from an index vector by the channel state information generation unit as illustrated in FIG. 7 according to an exemplary embodiment.

FIG. 9 is a flowchart showing a method for feeding back a vector index according to an exemplary embodiment.

FIG. 10 is a block diagram illustrating an apparatus for switching SU/MU-MIMO access schemes according to an exemplary embodiment in a wireless communication system for dynamically switching SU/MU-MIMO access schemes.

FIG. 11 is a block diagram illustrating a BS according to an exemplary embodiment of the present invention.

### DETAILED DESCRIPTION OF THE ILLUSTRATED EMBODIMENTS

Exemplary embodiments will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Same elements, features, and structures are denoted by same reference numerals throughout the drawings and the detailed description, and the size and proportions of some elements may be exaggerated in the drawings for clarity, illustration, and convenience.

In addition, terms, such as first, second, A, B, (a), (b), and the like may be used herein when describing components according exemplary embodiments of the present invention. Each of these terminologies is not used to define an essence, order, or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component. Further, as used herein, “at least one of” a list of elements or features includes one of each of the elements or features listed or only one of the elements or features selected from all of the elements or features listed.

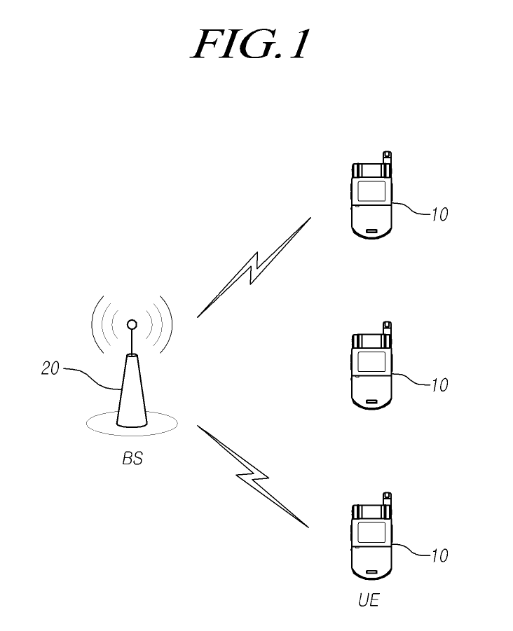

FIG. 1 illustrates a wireless communication system according to an exemplary embodiment of the present invention. Wireless communication systems are widely arranged in order to provide various communication services, such as voice, packet data, and the like.

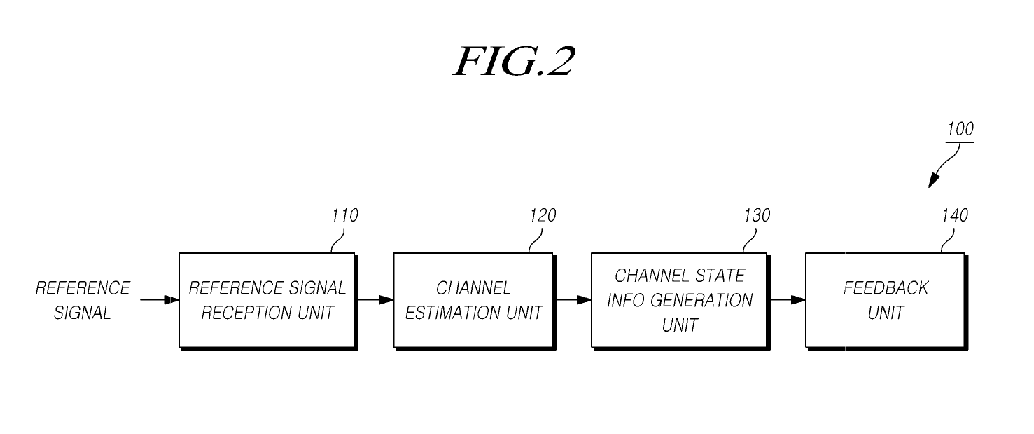

Referring to FIG. 1, a wireless communication system includes a UE (User Equipment) 10 and a BS (Base Station) 20. The wireless communication system may include multiple UEs 10. The UE 10 and the BS 20 use a multiple UE Multiple Input Multiple Output (MU-MIMO) channel information feedback method reflecting an additional UE access and a method of switching between a single UE (SU)-MIMO and the MU-MIMO by using the feedback method. Hereinafter, the MU-MIMO channel information feedback method and the method of switching between the SU-MIMO and the MU-MIMO by using the feedback method will be described in detail with reference to FIG. 2.

As used herein, the UE 10 may include a user terminal in a wireless communication, a UE in the WCDMA, LTE, HSPA (High Speed Packet Access), and the like, an MS (Mobile Station), a UT (User Terminal), an SS (Subscriber Station), a wireless device in the GSM (Global System for Mobile Communication), and the like.

The BS 20 may be a cell and may generally refer to a fixed station communicating with the UE 10, and may be a Node-B, eNB (evolved Node-B), BTS (Base Transceiver System), AP (Access Point), or relay node, and the like.

However, the UE 10 and the BS 20 are not limited to specifically expressed terms or words and inclusively indicate two transmitting and receiving elements used for implementation of the aspects of the present invention described herein.

An exemplary embodiment of the present invention can be applied to the asynchronous wireless communication, which may include the LTE (Long Term Evolution) and the LTE-A (LTE-advanced), the GSM, the WCDMA, and the HSPA, and the synchronous wireless communication, which may include the CDMA, the CDMA-2000, and the UMB. Aspects of the present invention shall not be restrictively construed based on a particular wireless communication field and shall be construed to include all technical fields to which the aspects of the present invention can be applied.

The present disclosure provides a scheme for improving an MU-MIMO operation through efficient antenna-specific power allocation and eigenvector feedback with a small feedback overhead, and a method for increasing the scheduling gain through implementation of dynamic switching between SU-MIMO and MU-MIMO by using the scheme.

In order to support high speed information transmission to many users, not only a technique of increasing the peak spectral efficiency that can be provided to users in a good channel condition but also a technique of increasing the cell average spectral efficiency and the peak spectral efficiency of users in a bad channel condition is necessary.

In order to achieve the latter two objects, use of the Multiple User Multiple Input is Multiple Output (MU-MIMO) technique, which simultaneously transfers information to multiple users through the same band by using a multiple antenna (MIMO antenna), is taken into consideration. When two or more UEs have a high channel propagation gain for the same band, the MU-MIMO allows the two users to share the band, so as to enable more users to use a wider band and a band having a better channel propagation gain, thereby improving the general spectral efficiency.

The biggest shortcoming of implementation of the MU-MIMO is that channel state information should be transferred to the BS. However, the SU-MIMO does not require a consideration of the Multiple Access Interference (MAI), and thus can achieve an excellent performance by a simple transfer of a PMI (Precoding Matrix Index) for the MIMO transmission scheme or a transmission scheme proper for the channel instead of direct transfer of channel information by each user.

However, in the case of the MU-MIMO, in order to enable a BS to detect an interference between users and perform a proper scheduling in consideration of the interference, each UE should transfer direct information on the channel to the BS, so that the BS can. Based on the direct information, perform precoding and scheduling capable of avoiding the interference between users. Since the direct transfer of channel information may cause a very large feedback overhead, it is inevitably necessary to develop a reasonable channel information transfer scheme.

Further, in order to increase the scheduling gain, which is the biggest advantage of the MU-MIMO system, a BS is required to be capable of performing a dynamic switching between the SU-MIMO scheme and the MU-MIMO scheme of each UE according to the channel situation of each UE. To this end, each UE should transfer the PMI and the channel information to the BS either simultaneously or with a time gap shorter than the channel switching period. Only when this requirement is satisfied, the BS can determine whether the SU/MU-MIMO is proper and can reasonably determine whether to perform the SU/MU-MIMO switching.

The present disclosure presents a feedback technique, which can reduce a feedback overhead necessary for supporting of the MU-MIMO scheme while preventing the reduction of the feedback overhead from degrading the general operation of the MU-MIMO in consideration of the MU-MIMO operation environment, and can support dynamic switching between SU-MIMO and MU-MIMO with a small feedback overhead.

The present disclosure provides a method and an apparatus, by which a UE feeds back channel information to a BS with a proper feedback overhead according to the situation and the BS communicates with the UE by using the channel information. As an example of the communication environment or operation environment for feedback of channel information to the BS by the UE with a proper feedback overhead, a dynamic switching between SU-MIMO and MU-MIMO is discussed, although aspects of the present invention are not limited by the example but can be applied to any communication environment or operation environment.

FIG. 2 is a block diagram illustrating a channel information feedback apparatus according to an exemplary embodiment in a MIMO system.

A MIMO channel information feedback apparatus 100 may be implemented by hardware or software in a User Equipment (UE), which is currently connected to a BS, or the like, or an additionally-connected UE, which attempts an additional access. However, aspects of the present invention are not limited thereto, and the MIMO channel information feedback apparatus 100 may be implemented in a Base Station (BS), etc.

The MIMO channel information feedback apparatus 100 according to an exemplary embodiment includes a reference signal reception unit 110 to receive a reference signal, e.g., a Channel State Index-Reference Signal (CSI-RS), from the BS; a channel estimation unit 120 to estimate a channel by using the received CSI-RS; a channel state information generation unit 130 to generate the relevant channel state information based on the result of the channel estimation by the channel estimation unit 120; and a feedback unit 140 to feed back the relevant channel state information.

The reference signal reception unit 110 and the channel estimation unit 120 may be separately implemented or may be implemented in an integrated manner.

The reference signal reception unit 110, which receives a CSI-RS unique for each cell, includes information on through which band (or subcarrier) and which symbol of a received signal the CSI-RS is received. Therefore, the reference signal reception unit 110 determines a signal in the time-frequency domain, and thereby can measure a reception value of the CSI-RS.

The CSI-RS is a reference signal that a BS transmits so that a UE can estimate a downlink channel. The UE receives the CSI-RS and estimates the downlink channel. Then, the UE searches for a PreCoding (hereinafter, referred to as “precoding” or “PC”) scheme and a Post-DeCoding (hereinafter, referred to as “post-decoding” or “PDC”) scheme, which are the most appropriate for the estimated channel.

The channel estimation unit 120 estimates a channel by using the received CSI-RS, and the channel estimation is performed as follows.

A reception value of the CSI-RS, which is received by the reference signal reception unit 110, is expressed by equation (1) below. In equation (1), r̅^{RS} represents a reception value of the received CSI-RS, H represents a propagation channel, t̅^{RS} represents a transmission value of the transmitted CSI-RS, and η̅ represents a Gaussian noise.

r̅^{RS}=H t̅^{RS}+η (1)

In equation (1), the reception value of the received CSI-RS r̅^{RS} can be obtained by the measurement as described above. The transmission value of the transmitted CSI-RS t̅^{RS} is a value which is already known between a BS and a UE. Therefore, the propagation channel H can be estimated by using the conventional channel estimation technique.

Then, the channel state information generation unit 130 generates channel state information based on the result of the channel estimation by the channel estimation unit 120. The channel state information may include information related to channel quality, e.g., a Channel Quality Indicator (CQI) value.

Also, the channel state information may include a single eigenvector having the closest eigenvalue or at least two eigenvectors in the order of magnitudes of eigenvalues among eigenvectors of a channel matrix or a covariance matrix other than a channel matrix or a covariance matrix itself. At this time, Hₙ represents a channel matrix or a covariance matrix of a UE n, and νₙ is referred to as an eigenvector in Hₙνₙ=λₙνₙ in which λₙ is a coding gain obtained when precoding is performed by using the eigenvector νₙ.

A method for performing precoding according to eigenvectors is a very powerful technique that can maximize the performance of a MIMO system when there is no threshold value in transmission power for each transmission antenna. Therefore, the method as described above can implement the MIMO system while causing small performance degradation of the MIMO system, as compared to a technique for feeding back the entire channel matrix. Also, a scheme for feeding back a small number of vectors has an advantage in terms of feedback overhead when compared with a scheme for feeding back the channel matrix.

If only some eigenvectors or vectors equivalent to eigenvectors are fed back without feeding back all eigenvectors, the amount of information, which is spatially multiplexed through a transmission rank, a simultaneous transmission layer, or precoding, is smaller than in the case of feeding back all eigenvectors. Consequently, the smaller amount of information may reduce peak spectral efficiency that each UE connected to MIMO can have.

A technique may be used for increasing an average spectral efficiency that each UE connected to the MIMO can have in an actual communication environment instead of reducing peak spectral efficiency that each UE connected to the MIMO can have in an ideal situation. The technique as described above reduces feedback overhead simultaneously with increasing the average spectral efficiency. The first reason for the reduction of the feedback overhead is that the amount of the feedback information is reduced. Also, a scheme for increasing the spectral efficiency will be described.

A wireless communication system allocates a band according to a channel situation of each UE. Instead of allowing a UE having a good channel state for a Single UE (SU)-MIMO, the wireless communication system allocates a very narrow band to it, and thereby secures a band that another UE can use. The wireless communication system allocates a wide band to another UE having a bad channel state, and supports an appropriate data rate. Instead, the wireless communication system increases cell spectral efficiency through multiple accesses to other users. Namely, the above description implies that a user connected in an MU-MIMO (Multiple-User Multiple-Input Multiple-Output) has usually a smaller channel propagation gain than another user connected in the SU-MIMO (Single-User Multiple-Input Multiple-Output). In this regard, the small channel propagation gain signifies a small amount of information which can be simultaneously received through spatial multiplexing. A technique capable of increasing power of a signal, which is received with low power due to a small channel propagation gain, may be applied to a UE connected in the MU-MIMO to increase cell capacity and performance of each UE rather than a technique for simultaneously transmitting much information through spatial multiplexing.

The number of feedback eigenvectors may be reduced and only low rank transmission may be allowed, and therefore small performance degradation may occur. However, instead, eigenvectors may be modified in a scheme which is more appropriate to an actual communication system having limits on transmission power for each antenna, and the modified eigenvectors may then be fed back, which increases reception power of a UE connected in the MU-MIMO. For example high resolution channel information may correspond to channel information indexed or expressed by larger quantity of bits than low resolution channel information which may be fed back, and low resolution channel information may correspond to channel information indexed or expressed by less quantity of bits than high resolution channel information which may be fed back.

In terms of principles, eigenvectors may have various values. Particularly, if antennas are configured in such a manner that there may be a low correlation between antennas in order to obtain high spectral efficiency in the SU-MIMO, eigenvectors have such various magnitudes and phases that it is not easy to quantize them.

For example, 2 UEs u₀ and u₁ may transmit eigenvectors, which are respectively equivalent to eigenvectors ν₀ and ν₁ expressed by equation (2) below, to a BS. It is assumed that the BS uses 4 transmission antennas and each UE uses 4 reception antennas.

$${v}_{0} = \frac{1}{{T}_{0}} [ \begin{matrix}7 {e}^{jπ / 7} \\ 0.5 {e}^{j2π / 3} \\ {e}^{jπ / 2} \\ 1.25 {e}^{- jπ / 9}\end{matrix} ] \\ {v}_{1} = \frac{1}{{T}_{1}} [ \begin{matrix}6 {e}^{j5π / 3} \\ 3 {e}^{jπ / 5} \\ 0.1 {e}^{j3π / 2} \\ 0.7 {e}^{j8π / 9}\end{matrix} ] \qquad ( 2 )$$

where

$$\frac{1}{{T}_{n}}$$

represents a normalization factor of each UE n.

When transmitting information by using the eigenvectors ν₀ and ν₁ in the MU-MIMO, each antenna transmits values expressed by equation (3) below.

$$Tx = {P}_{A} ( \frac{{d}_{0}}{{T}_{0}} [ \begin{matrix}7 {e}^{jπ / 7} \\ 0.5 {e}^{j2π / 3} \\ {e}^{jπ / 2} \\ 1.25 {e}^{- jπ / 9}\end{matrix} ] + \frac{{d}_{1}}{{T}_{1}} [ \begin{matrix}6 {e}^{j5π / 3} \\ 3 {e}^{jπ / 5} \\ 0.1 {e}^{j3π / 2} \\ 0.7 {e}^{j8π / 9}\end{matrix} ] ) \qquad ( 3 )$$

In equation (3), P_{A} represents amplification by a transmission end amplifier, and dₙ represents a symbol which is intended to be delivered to each UE n. Each element of Tx represents signals that the 4 transmission antennas output.

As can be seen from equation (3), outputs of the 4 transmission antennas become significantly different. In a general communication system in which all antennas have equal or similar maximum output values, the output of each antenna is limited by

$${P}_{A} {\vert \frac{7 {d}_{0} {e}^{jπ / 7}}{{T}_{0}} + \frac{6 {d}_{1} {e}^{j5π / 3}}{{T}_{1}} \vert}^{2}$$

which is the largest output among the outputs of the 4 transmission antennas that transmit signals. Therefore, only the transmission antenna, which corresponds to the highest value among the 4 transmission antennas transmitting signals indicated by Tx, can use the maximum usable output. Accordingly, each of the remaining antennas should transmit a signal by using lower output.

For example, if an output of the transmission antenna corresponding to the first element included in Tx is named P₀, the transmission antenna corresponding to the third element included in Tx should transmit information only by using power

$${P}_{0} \frac{{\vert \frac{{d}_{0} {e}^{jπ / 2}}{{T}_{0}} + \frac{0.1 {d}_{1} {e}^{j3π / 2}}{{T}_{1}} \vert}^{2}}{{\vert \frac{7 {d}_{0} {e}^{jπ / 7}}{{T}_{0}} + \frac{6 {d}_{1} {e}^{j5π / 3}}{{T}_{1}} \vert}^{2}} .$$

Therefore, the output efficiency of a power amplifier is very low, and the low output efficiency significantly reduces not only transmission efficiency but also the received strength of a signal.

If it is intended to avoid inefficient power operation as clearly described above, eigenvectors can be slightly changed in forms thereof instead of using the eigenvectors as a precoding matrix as they are.

According to aspects of the present invention, each eigenvector may be transformed to a vector, which includes elements having specific magnitudes and different phases, and the transformed vector may then be fed back. In this case, the concept of the ‘specific magnitudes’ includes not only equal magnitudes but also substantially same or similar magnitudes of the elements included in the vector.

For example, the eigenvectors ν₀ and ν₁ are replaced by vectors q₀ and q₁ each of which includes elements having predetermined magnitudes and different phases expressed by equation (4) below. Then, the replaced vectors q₀ and q₁ are transmitted to the BS.

$${q}_{0} = \frac{1}{2} [ \begin{matrix}{e}^{{jα}_{0}} \\ {e}^{{jα}_{1}} \\ {e}^{{jα}_{2}} \\ {e}^{{jα}_{3}}\end{matrix} ] \\ {q}_{1} = \frac{1}{2} [ \begin{matrix}{e}^{{jβ}_{0}} \\ {e}^{{jβ}_{1}} \\ {e}^{{jβ}_{2}} \\ {e}^{{jβ}_{3}}\end{matrix} ] \qquad ( 4 )$$

In equation (4), αₙ represents phase values of the elements of the vector q₀, and βₙ represents phase values of the elements of the vector q₁.

If precoding is performed by using the vectors q₀ and q₁, all antennas can use maximum outputs thereof, and accordingly the strength of a signal that each UE receives can be significantly increased as compared with the example as described above.

Hereinafter, a description will be made of a method for determining the phase values αₙ and βₙ of the respective elements of the vectors q₀ and q₁.

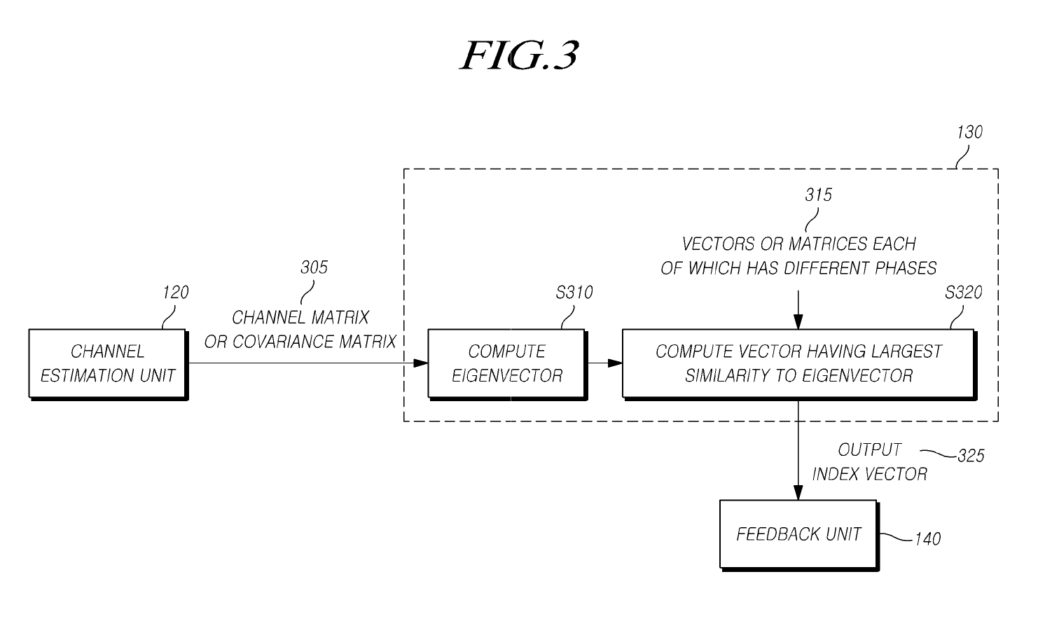

FIG. 3 is a flowchart illustrating determining phase values of elements having specific magnitudes and different phases as each eigenvector by the channel state information generation unit 130 as illustrated in FIG. 2 according to an exemplary embodiment.

Referring to FIG. 3, first, the channel state information generation unit 130 receives a channel or covariance matrix 305 from the channel estimation unit 120. The received channel or covariance matrix 305 is the result of the channel estimation by the channel estimation unit 120. Then, the channel state information generation unit 130 computes eigenvectors in operation S310. The computation of the eigenvectors in operation S310 includes the computation of an eigenvector νₙ, which includes the reflection of a coding gain λₙ obtained when precoding is performed by using a channel or covariance matrix Hₙ and νₙ of a UE n in Hₙνₙ=λₙνₙ, which is the definition of an eigenvector. One of the computed eigenvectors may be ν₀ or ν₁ as expressed in equation (2).

Thereafter, in operation S320, the channel state information generation unit 130 searches for values which have the largest similarity to an eigenvector among vectors or matrices 315, each of which has specific magnitudes but different phases as expressed in equation (4).

As the result of operation S320, the channel state information generation unit feeds back or outputs an index vector 325 having predetermined magnitudes and different phases, which has the largest similarity to the eigenvector. At this time, each of the vectors q₀ and q₁ may include previously-selected values or values which can be generated by specific rules.

The index vector may be a high resolution index vector or a low resolution index vector. The high resolution index vector may include a larger quantity of information than the low resolution index vector.

For example, a total of 100 q s are selected, and then a vector, which has the largest similarity to the eigenvector ν₀ among a total of the 100 q s, can be selected as q₀. For example, the channel state information generation unit generates various vectors in each of which elements have phases expressed by multiples of 45 degrees, and may then select a vector, which has the largest similarity to the eigenvector ν₀ among the various generated vectors, as an index vector q₀. At this time, the large similarity between the eigenvector ν₀ and the index vector q₀, for example, may signify the shortest chordal distance between the 2 vectors. However, aspects of the present invention are not limited thereto.

As described in the above example, the selection is made of the vector, which has the largest similarity or is most similar to the eigenvector ν₀. However, a selection may be made of a vector whose similarity to the eigenvector is larger than a threshold value which can express a channel state. In this case, the threshold value may be selected by an operator of the BS, or may be determined in consideration of the degree of mutual interference between channels, etc. Similarly, the selection of a vector whose similarity to the eigenvector is larger than a threshold value which can express a channel state, for example, may imply that a chordal distance between the 2 vectors is smaller than the threshold value. However, aspects of the present invention are not limited thereto.

As the result of operation S320, an index vector can be output 325 to the feedback unit 140, as illustrated in FIG. 2.

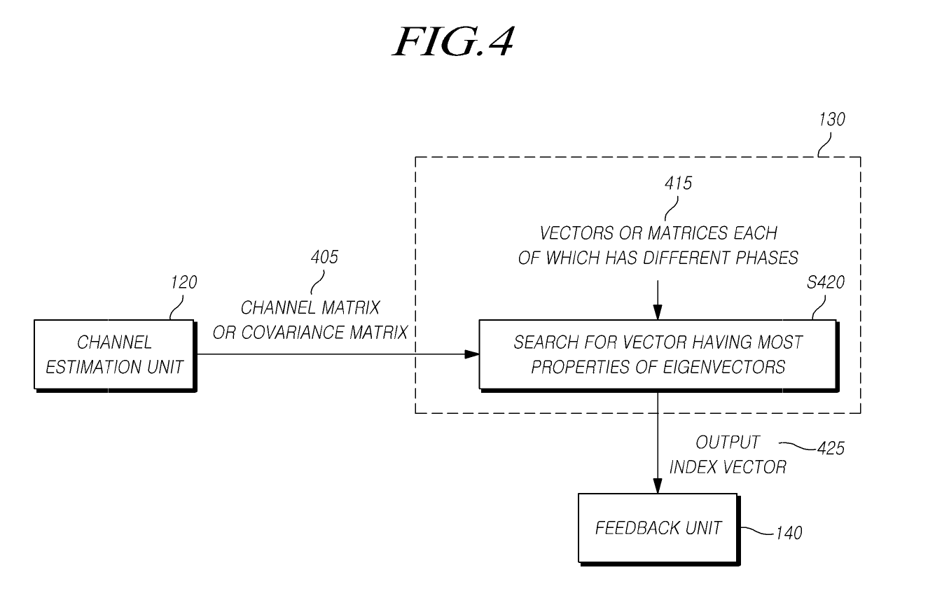

FIG. 4 is a flowchart illustrating determining phase values of elements having specific magnitudes and different phases as each eigenvector by the channel state information generation unit 130 as illustrated in FIG. 2 according to an exemplary embodiment.

Referring to FIG. 4, first, the channel state information generation unit 130 receives a channel and/or covariance matrix 405 from the channel estimation unit 120, and the channel state information generation unit 130 receives, generates, or has previously stored vectors or matrices 415 each of which has specific magnitudes but different phases. The channel and/or covariance matrix 405 is the result of the channel estimation by the channel estimation unit 120. Then, the channel state information generation unit 130 searches for a vector having the most properties of eigenvectors in operation S420. Differently from the exemplary embodiment shown in FIG. 3, in which the channel state information generation unit 130 computes an eigenvector by using the channel or covariance matrix 405 and then computes a vector having the largest similarity to the eigenvector, the channel state information generation unit can directly search for a vector having the most properties of the eigenvectors from the channel or covariance matrix 405 in operation S420 shown in FIG. 4 as described below.

λₙ is a coding gain which is obtained when precoding is performed by using the eigenvector νₙ in Hₙνₙ=λₙνₙ, which is the definition of an eigenvector, as described above. Therefore, superior performance can be obtained in a scheme for selecting an index vector which renders signal distortion small while ensuring a large coding gain and then feeding back the selected index vector.

For example, a vector, which has a maximum Objective Factor (hereinafter, referred to as “OF”) defined by equation (5) below, can be selected as an index vector having the most properties of the eigenvectors.

$$OF = {Max}_{j} [ \frac{\vert {λ}_{j} \vert}{\vert {λ}_{j} {C}_{j} - {HC}_{j} \vert} ] \qquad ( 5 )$$

In equation (5), |λₙCₙ−HₙCₙ| represents the degree of signal distortion occurring when C, is fed back instead of an eigenvector νₙ, and |λₙ| represents a gain obtained when precoding is performed. Namely, Cₙ, which has the largest gain of precoding over the degree of the signal distortion, can be selected as the index vector having the most properties of the eigenvectors.

As the result of operation S420, the vector, which has the most properties of the eigenvectors, as the index vector can be output 425 to the feedback unit 140, as illustrated in FIG. 2. In this case, the description has been made as feeding back the index vector having the most properties of the eigenvectors. However, a selection may be made of a vector having the property of the eigenvector larger than a threshold value which can express a channel state, and then an index of the selected vector may be fed back. Namely, in equation (5), Cₙ, which is obtained when an OF value is larger than the threshold value, may be selected as the vector having the most properties of the eigenvectors. In this case, the threshold value may be selected by an operator of a BS, or may be determined in consideration of the degree of mutual interference between channels, etc.

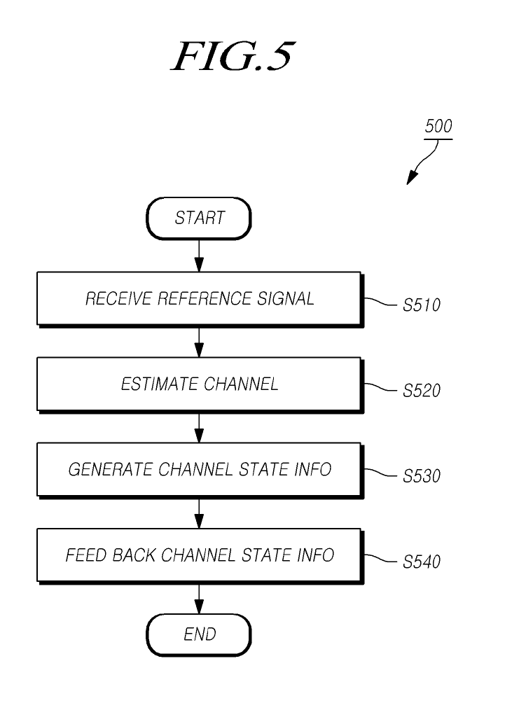

FIG. 5 is a flowchart showing a channel information feedback method according to an exemplary embodiment in the MIMO system.

A MIMO channel information feedback method 500 according to an exemplary embodiment includes a reference signal reception operation S510 for receiving a reference signal, e.g., a Channel State Index-Reference Signal (CSI-RS), from a BS; a channel estimation operation S520 for estimating a channel by using the received CSI-RS; a channel state information generation operation S530 for generating the relevant channel state information based on the result of the channel estimation in the channel estimation operation S520; and a feedback operation S540 for feeding back the channel state information.

The reference signal reception operation S510 and the channel estimation operation S520 may be separately implemented or may be implemented in an integrated manner.

In the reference signal reception operation S510, a CSI-RS unique for each cell is received, and memory storage is maintained for information on through which band (or subcarrier) and which symbol of a received signal the CSI-RS is received. Therefore, it determines a signal in the time-frequency domain, and thereby can measure a reception value of the CSI-RS.

In the channel estimation operation S520, a channel is estimated by using the received CSI-RS, and the channel estimation is performed as follows. The CSI-RS, which has been received in the reference signal reception operation S510, has the reception value thereof as expressed by equation (1).

In the channel state information generation operation S530, the channel state information is generated based on the result of the channel estimation in the channel estimation operation S520. The channel state information may include at least one of a CQI (Channel Quality Indicator) value, a PMI (Precoding Matrix Index), and an RI (Rank Indicator).

Also, the channel state information may include a single eigenvector having the largest eigenvalue or at least two eigenvectors in the order of magnitudes of eigenvalues among eigenvectors of a channel matrix or a covariance matrix other than a channel matrix or a covariance matrix itself, as described with reference to FIG. 3, and either an index vector whose similarity to an eigenvector is largest among vectors or matrices each of which has specific magnitudes but different phases, or an index vector having the most properties of eigenvectors among vectors or matrices, each of which has specific magnitudes but different phases, as previously described with reference to FIG. 4.

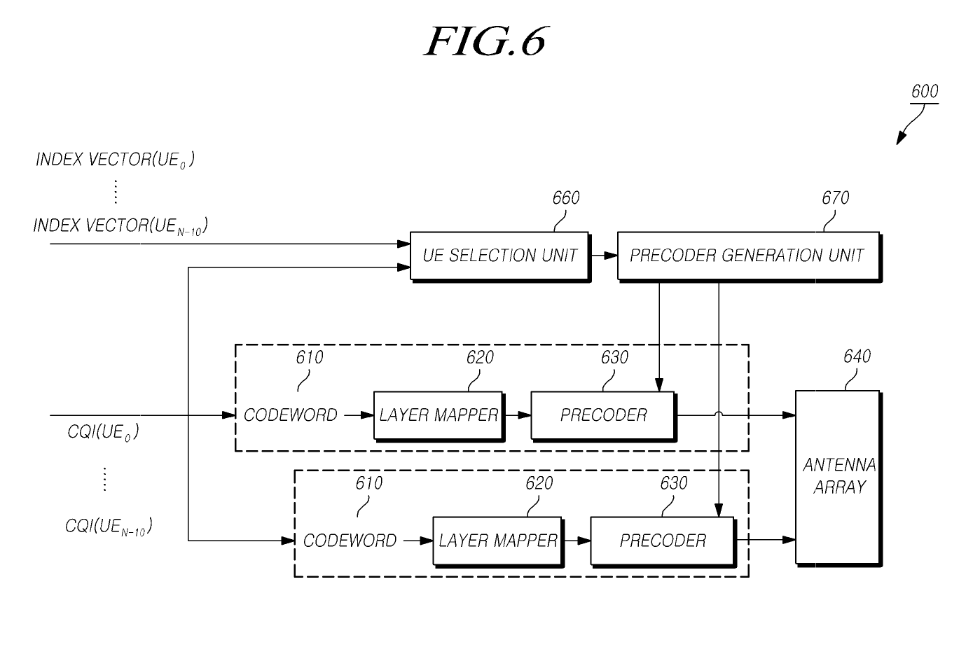

FIG. 6 is a block diagram illustrating a BS according to an exemplary embodiment. A BS or BS apparatus 600 includes a layer mapper 620 to map a codeword 610 to a layer; a precoder 630 to precode symbols; and an antenna array 640 having at least two antennas to propagate or transmit the precoded symbols into the air.

Also, the BS 600 includes a UE selection unit 660 and a precoder generation unit 670.

When performing MIMO, the BS 600 must detect a correlation between UE channels. Each UE transmits channel state information on a propagation channel or a channel matrix, as a CQI value and an index vector (i.e., a PMI), to the BS 600. The BS 600 compares multiple pieces of the channel state information that the UEs have transmitted, and detects the correlation between the UE channels.

The UE selection unit 660 selects UEs based on the received CQI values and index vectors that the UEs have reported to the UE selection unit 660. The UE selection unit 660 determines the correlation between the UE channels based on the received CQI values and index vectors that the UEs have reported to the UE selection unit 660. Then, the UE selection unit 660 selects the UEs, which satisfy particular conditions, depending on the determined correlation. At this time, the UEs, which satisfy the particular conditions, may signify the UEs having the smallest channel interference between the UEs. However, aspects of the present invention are not limited thereto.

The precoder generation unit 670 generates a precoding matrix of the UEs selected by the UE selection unit 660. The precoder generation unit 670 generates the precoding matrix of the UEs based on the received CQI values and index vectors that the UEs selected by the UE selection unit 660 have reported to the UE selection unit 660.

The existing techniques for receiving as input a channel or covariance matrix typically use a precoding scheme for finding eigenvectors of a channel and performing eigenvector-based precoding, or another precoding scheme for finding an inverse matrix of a reception channel or a covariance matrix and performing zero-forcing precoding. When compared with the technique in the exemplary embodiments for feeding back an eigenvector, the eigenvector-based precoding among the conventional schemes not only has a large feedback overhead, but also has low power efficiency, low transmission power and low reception power due to the characteristics as clearly described above. Also, the zero-forcing precoding has a superior interference control capability, but has a characteristic vulnerable to thermal noise. Therefore, the zero-forcing precoding shows inferior performance to the eigenvector-based precoding in the majority of systems.

Hitherto, the above description has been made of an apparatus and a method for channel information feedback, and a BS corresponding to the apparatus and the method for the channel information feedback according to an exemplary embodiment in a MIMO system. Hereinafter, a sequential description will be made of an apparatus for channel information feedback, and an apparatus and a method for switching SU/MU-MIMO access schemes according to an exemplary embodiment in a wireless communication system for dynamically switching SU/MU-MIMO access schemes.

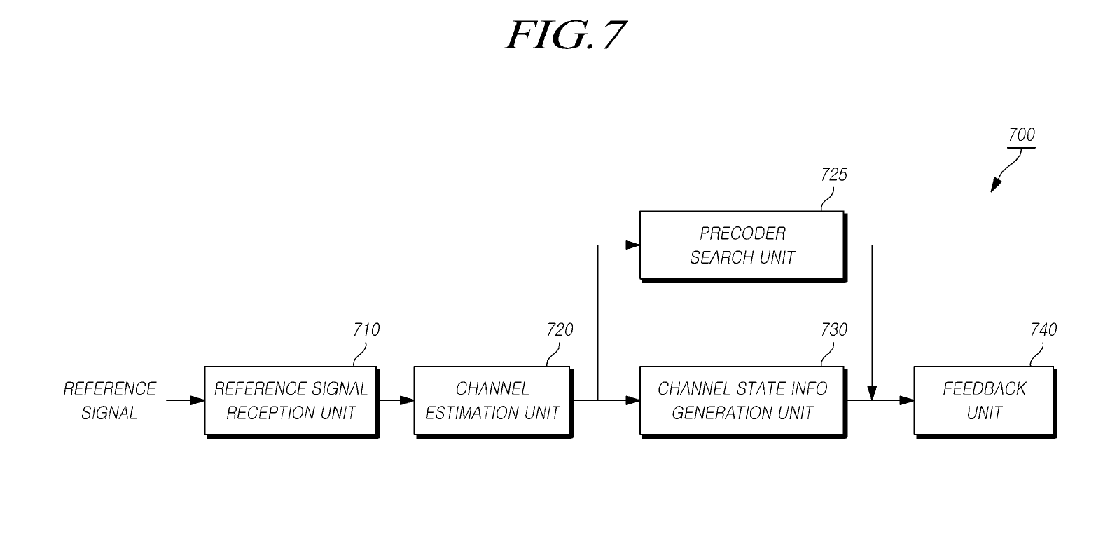

FIG. 7 is a block diagram illustrating a channel information feedback apparatus according to an exemplary embodiment in a wireless communication system. Referring to FIG. 7, in a wireless communication system, a channel information feedback apparatus 700 according to an exemplary embodiment includes a reference signal reception unit 710 to receive a reference signal, e.g., a Channel State Index-Reference Signal (CSI-RS), from the BS; a channel estimation unit 720 to estimate a channel by using the received CSI-RS; a precoder search unit 725 to estimate the type of a precoder of a relevant UE and to search for an optimal precoder based on the result of the channel estimation by the channel estimation unit 720; a channel state information generation unit 730 to generate the relevant channel state information based on the result of the channel estimation by the channel estimation unit 720; and a feedback unit 740 to feed back the searched precoder type and the generated channel state information.

The reference signal reception unit 710 and the channel estimation unit 720 are similar or substantially similar to the reference signal reception unit 110 and the channel estimation unit 120 as described above with reference to FIG. 2. Therefore, a description of the reference signal reception unit 710 and the channel estimation unit 720 will not be described again.

Next, the precoder search unit 725 estimates the type of a precoder of another relevant connected UE based on the result of the channel estimation by the channel estimation unit 720. Also, the precoder search unit 725 searches for an optimal precoder and an optimal post-decoder based on the result of the channel estimation by the channel estimation unit 720. Further, the precoder search unit 725 can detect a reception value and the interference of a desired signal. Therefore, the precoder search unit 725 can determine an optimal precoding scheme or an optimal precoder, and an optimal post-decoding scheme or an optimal post-decoder by using various precoding techniques.

For example, the precoder search unit 725 may determine an optimal precoder and an optimal post-decoder by searching a precoder codebook. However, aspects of the present invention are not limited thereto such that other precoding design techniques may be used.

The precoder search unit 725 can determine a Precoding Matrix Index (PMI) of a precoder codebook on an optimal precoder type of a connected UE. The PMI is an identifier for indicating an optimal precoding matrix that a UE is to use, i.e., channel information.

The UE transmits information on a precoder, which the UE determines to be most optimal, to a BS by using the PMI. At this time, the UE transmits a channel quality, which the UE determines to be able to obtain, to the BS by using a CQI.

When generating a PMI, the precoder search unit 725 may generate a high-resolution PMI, which causes a large feedback overhead due to large amounts of feedback information but can indicate an optimal precoding matrix, and a low-resolution PMI, which causes a small feedback overhead due to a small amount of feedback information but can not indicate an optimal precoding matrix.

For example, high-resolution PMIs may signify all PMIs of a specific precoder codebook, and low-resolution PMIs may be clustered PMIs obtained by grouping PMIs having similar properties into one cluster among all PMIs of a specific precoder codebook. The number of high-resolution PMIs, for example, is ‘1’ for rank=1, ‘4’ for rank=2, and ‘16’ for rank=4. Therefore, the high-resolution PMIs need a total of 4 bits to be expressed. If 4 PMIs, for example, are grouped into one cluster, 4 low-resolution PMIs are determined and therefore a total of 2 bits may be needed.

The high-resolution PMI, for example, may be fed back to the BS by the feedback unit 740. The low-resolution PMI, for example, may be fed back to the BS by the feedback unit 740. The feedback unit 740 can feed back PMI information as low-resolution PMIs in the range of causing no problems in determining a precoder of the BS while rendering the amount of information, which the feedback unit 740 reports, as small as possible. As described in the above example, when the SU/MU-MIMO access schemes are dynamically switched, a UE feeds back one of a high-resolution PMI and a low-resolution PMI to a BS. However, aspects of the present invention are not limited thereto. Accordingly, the UE can feed back at least one of a high-resolution PMI and a low-resolution PMI to the BS according to any communication states or any communication environments.

The channel state information generation unit 730 generates the relevant channel state information based on the result of the channel estimation by the channel estimation unit 720. The channel state information, which the channel state information generation unit 730 generates, may have the form of an index vector as described above, but aspects of the present invention are not limited thereto.

The channel state information generation unit 730 may generate at least one of a high-resolution PMI, a low-resolution PMI, a high-resolution index vector, and a low-resolution index vector, as the channel state information.

In this case, the precoder search unit 725 and the channel state information generation unit 730 are shown in FIG. 7. However, if one of the first channel state information and the second channel state information is selectively fed back as described below, only one of the precoder search unit 725 and the channel state information generation unit 730 either may be included, may operate, or may be implemented as one element by hardware or software.

The feedback unit 740 reports at least one of the first channel state information and the second channel state information to the BS. As described above, the feedback unit 740 may feed back at least one of a high-resolution PMI and a low-resolution PMI as the first channel state information to the BS. Also, the feedback unit 740 may feed back at least one of a high-resolution index vector and a low-resolution index vector as the second channel state information to the BS. As shown in Table 1 below, in an SU-MIMO state, the feedback unit 740, for example, may feed back a high-resolution PMI as the first channel state information to the BS, and may feed back a low-resolution index vector as the second channel state information to the BS. Further, as shown in Table 1 below, in an MU-MIMO state, the feedback unit 740 may feed back a low-resolution PMI as the first channel state information to the BS, and may feed back a high-resolution index vector as the second channel state information to the BS.

TABLE 1

| | | MU-MIMO access |
|---|---|---|
| | SU-MIMO access scheme | scheme |
| First channel state | High-resolution PMI | Low-resolution PMI |
| information | | |
| Second channel state | Low-resolution Index | High-resolution |
| information | vector | Index vector |

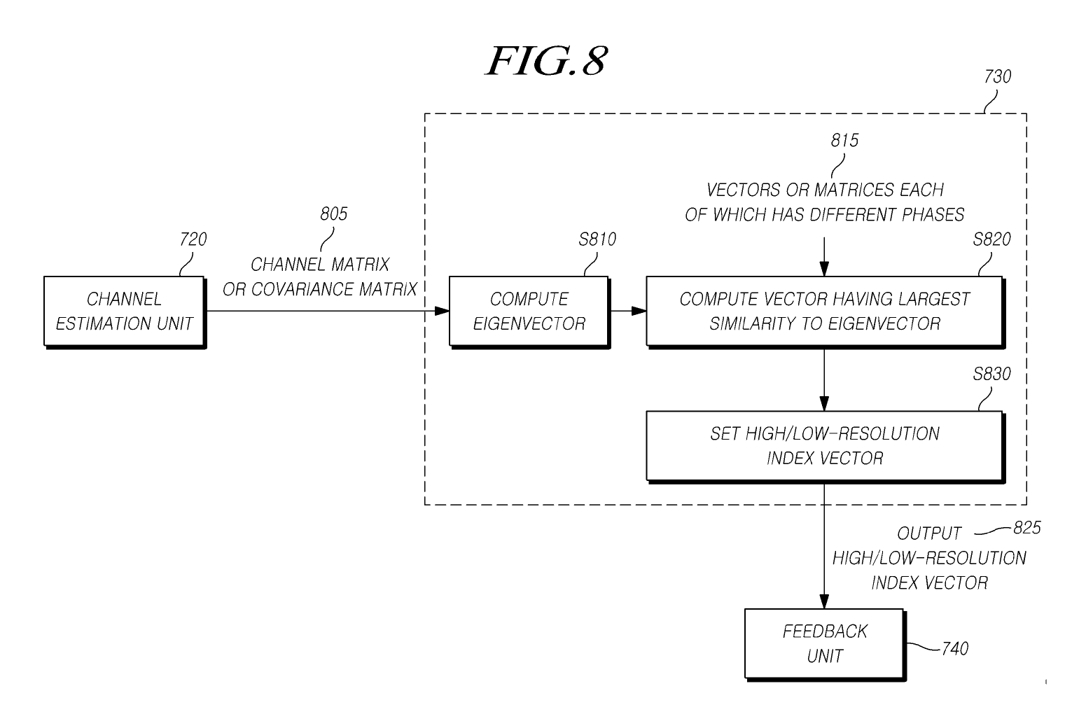

FIG. 8 is a flowchart showing a method for generating a high-resolution index vector and a low-resolution index vector from an index vector, which has elements having specific magnitudes and different phases as each eigenvector, by the channel state information generation unit 730 as illustrated in FIG. 7 according to an exemplary embodiment.

Referring to FIG. 8, first, the channel state information generation unit 730 receives a channel or covariance matrix 805 from the channel estimation unit 720. The channel or covariance matrix 805 is the result of the channel estimation by the channel estimation unit 720. Then, the channel state information generation unit 730 computes eigenvectors in operation S810. Operation S810 may be the same as or similar to operation S310 shown in FIG. 3.

Thereafter, the channel state information generation unit 730 searches for values which have the largest similarity to an eigenvector among vectors or matrices 815, each of which has specific magnitudes but different phases, and thereby determines a high-resolution index vector in operation S820. For example, a total of 100 q s are selected, and then a vector q, which has the largest similarity to an eigenvector ν₀ among a total of the 100 q s, can be selected as q₀. For example, the channel state information generation unit 730 generates various vectors in each of which elements have phases expressed by multiples of 15 degrees, and may then select a vector, which has the largest similarity to the eigenvector ν₀ among the various generated vectors, as q₀.

Also, in operation S820, a low-resolution index vector can be determined from a high-resolution index vector. For example, a total of 100 q s are selected, and then vectors q s, of which similarities to the eigenvector ν₀ belong to a specific range among a total of the 100 q s, are grouped into one cluster. Then, the low-resolution vector indexes may be the vectors q s grouped into one cluster. The low-resolution vector indexes may be various vectors in each of which elements have phases expressed by multiples of 45 degrees. If a high-resolution index vector, of which phases are multiples of 15 degrees, is taken into consideration in the latter case, the number of the low-resolution vector indexes corresponds to one third of that of the high-resolution vector indexes. Namely, there may be the original first PMI table, and there may be the second PMI table in which PMIs, which satisfy pre-set conditions in the first PMI table, are configured in the form of a subset.

As the result of operation S820, the channel state information generation unit 730 may set the low-resolution index vector in operation S830. Then, the channel state information generation unit 730 may output the set low-resolution index vector 825 to the feedback unit 740 as shown in FIG. 7. The channel state information generation unit may set the high-resolution index vector in operation S830, and may output the set high-resolution index vector 825 to the feedback unit 740. In an SU-MIMO state, the channel state information generation unit, for example, sets a low-resolution index vector in operation S830, and then outputs the set low-resolution vector index 825 to the feedback unit 740. In an MU-MIMO state, it sets a high-resolution index vector in operation S830, and then outputs the set high-resolution index vector 825 to the feedback unit 740.

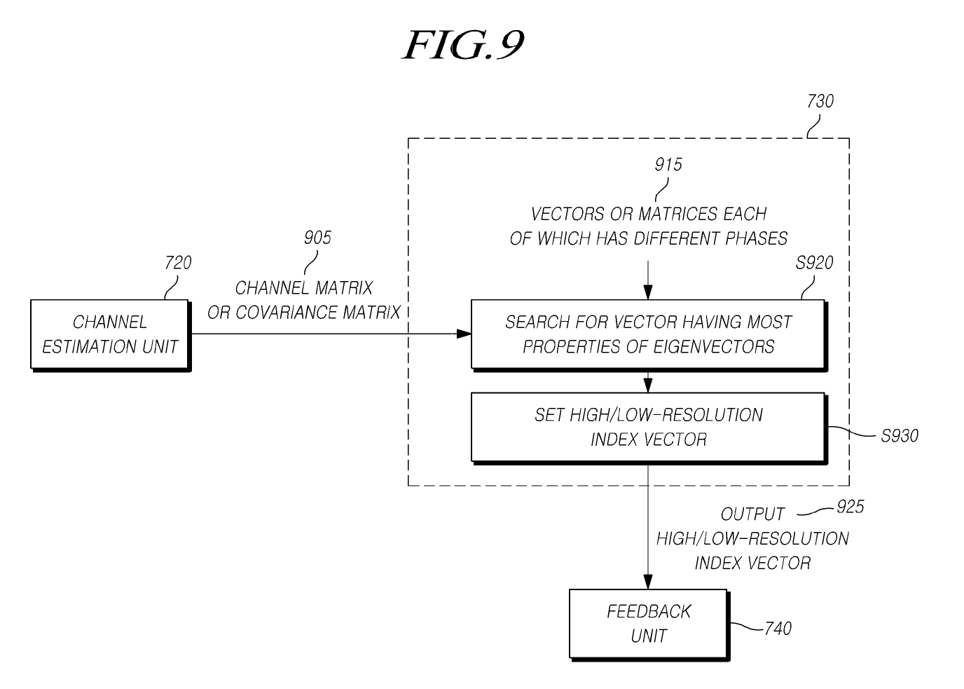

FIG. 9 is a flowchart showing a method for feeding back a vector index according to an exemplary embodiment. Referring to FIG. 9, first, the channel state information generation unit 730 receives a channel or covariance matrix 905 from the channel estimation unit 720. The channel or covariance matrix 905 is the result of the channel estimation by the channel estimation unit 720. Then, the channel state information generation unit 730 searches for a vector having the most properties of eigenvectors among vectors or matrices each of which has different phases 915 in operation S920. As described above with reference to FIG. 4, the channel state information generation unit 730, for example, may select a vector having the maximum OF as a high-resolution index vector by using equation (5).

After the determination of the high-resolution index vector, schemes for obtaining a low-resolution index vector from the determined high-resolution index vector can be classified into 2 types. For example, first, some vectors having large chordal distances therebetween are selected among vectors stored (i.e. previously-selected) in a codebook. The selection scheme may follow a general scheme for ‘grouping and the selection of representative values.’ A low-resolution vector index can be obtained in such a scheme that OFs are computed only by using the representative value vectors in equation (5) and a search is made for a vector having the maximum OF among the computed OFs. Second, by checking which group includes a high-resolution vector index among groups defined in the above scheme, a representative value vector of a group, which includes the high-resolution index vector, may be selected as a low-resolution index vector.

As the result of operation S920, the vector, which has the most properties of the eigenvectors, is set to the high-resolution index vector in operation S930. The low-resolution index vector is set from the high-resolution index vector in operation S930. Then, the high-resolution index vector or the low-resolution index vector 925 is output to the feedback unit 740 as shown in FIG. 7. In an MU-MIMO state, the channel state information generation unit 730, for example, sets the vector, which has the most properties of the eigenvectors, to the high-resolution index vector in operation S930. In an SU-MIMO state, the channel state information generation unit 730 sets the vector, which has the most properties of the eigenvectors, to a low-resolution index vector in operation S930. Then, the channel state information generation unit 730 outputs the high-resolution index vector 925 or the low-resolution index vector 925 to the feedback unit 740 as shown in FIG. 7.

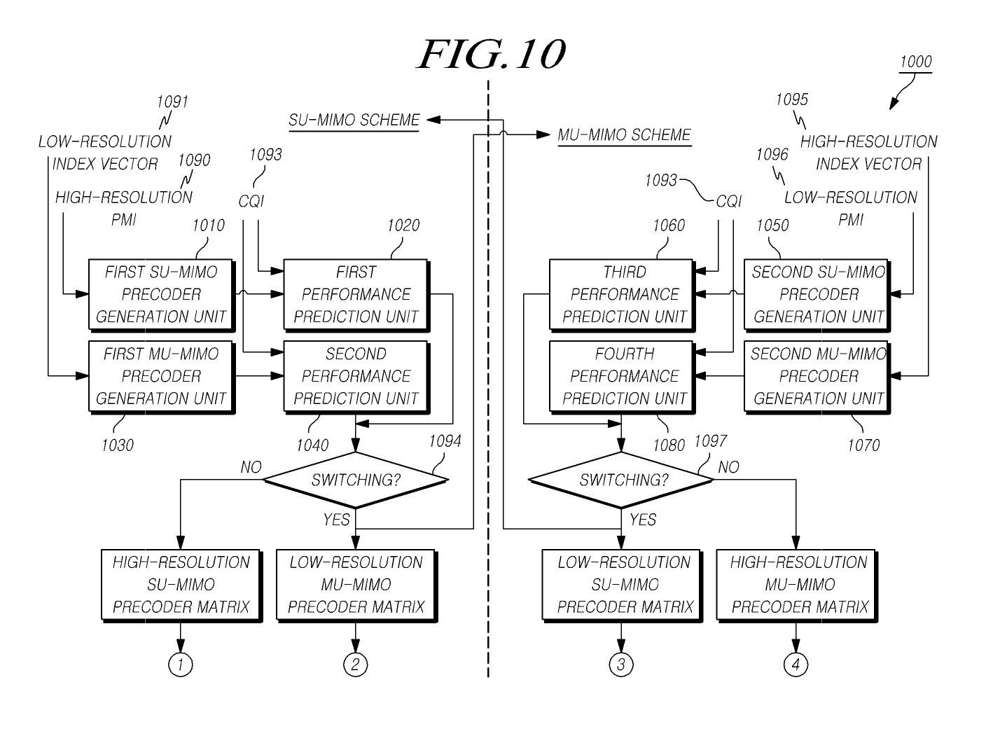

Hitherto, the above description has been made of an apparatus and a method for channel information feedback according to an exemplary embodiment in a wireless communication system. Hereinafter, an apparatus and a method for switching SU/MU-MIMO access schemes, to which an exemplary embodiment is illustratively applied, will be described with reference to FIG. 10.

Specifically, aspects of the present invention provide a scheme for performing eigenvector feedback with a small feedback overhead and improving an MU-MIMO operation through efficient power allocation for each antenna, and an apparatus and a method for implementing dynamic switching between SU-MIMO and MU-MIMO and increasing a scheduling gain by applying the above scheme.

In order to support high-speed information transmission for many users, aspects of the present invention provide a technique for increasing peak spectral efficiency which can be provided to a user having a good channel state, and a technique for increasing cell average spectral efficiency and cell edge spectral efficiency of a user who is in a poor channel environment.

Aspects of the present invention provide a feedback technique in which feedback overhead to support the MU-MIMO is reduced and the reduction of the feedback overhead decreases degradation of the overall operation of the MU-MIMO in consideration of an MU-MIMO operating environment, and simultaneously, it is possible to support dynamic switching between the SU-MIMO and the MU-MIMO with a small feedback overhead by applying the above technique.

FIG. 10 is a block diagram illustrating an apparatus to switch SU/MU-MIMO access schemes according to an exemplary embodiment in a wireless communication system for dynamically switching SU/MU-MIMO access schemes. Although features and/or elements are shown as separate, aspects need not be limited thereto such that the features and/or elements may be combined into fewer plural features and/or elements or a single features and/or element.

An apparatus 1000 to switch between SU/MU-MIMO access schemes according to an exemplary embodiment dynamically switches between the SU/MU-MIMO access schemes. The apparatus 1000 includes a first SU-MIMO precoder generation unit 1010 and a first performance prediction unit 1020, which are used to operate in the SU-MIMO access scheme; a first MU-MIMO precoder generation unit 1030; a second performance prediction unit 1040; a second SU-MIMO precoder generation unit 1050 and a third performance prediction unit 1060, which are used to operate in the MU-MIMO access scheme; a second MU-MIMO precoder generation unit 1070; and a fourth performance prediction unit 1080.

If operating in the SU-MIMO access scheme in the wireless communication system for dynamically switching the SU/MU-MIMO access schemes, the apparatus 1000 to switch the SU/MU-MIMO access schemes according to an exemplary embodiment receives low-resolution channel state information, e.g., a low-resolution index vector 1091 and a CQI 1093, which is used to determine whether switching to the MU-MIMO access scheme is performed and is fed back, along with a high-resolution PMI 1090 from UEs as described above. At this time, a UE, which operates in the SU-MIMO access scheme, feeds back the high-resolution PMI 1090 in response to the SU-MIMO access scheme in which the UE currently operates. Then, the high-resolution PMI 1090, which has been fed back as described above, is input to the first SU-MIMO precoder generation unit 1010. On the other hand, the UE feeds back the low-resolution index vector 1091 in response to the MU-MIMO access scheme in which the UE does not currently operate. Then, the low-resolution index vector 1091, which has been fed back as described above, is input to the first MU-MIMO precoder generation unit 1030. The high-resolution PMI 1090 and the low-resolution index vector 1091 may be fed back simultaneously or at different times. Thereafter, if the UE needs to switch from the SU-MIMO access scheme to the MU-MIMO access scheme, the BS determines a precoder with reference to the low-resolution PMI which has been fed back for an MU-MIMO operation. In this regard, a more detailed description will be made hereinafter.

The first SU-MIMO precoder generation unit 1010 generates a precoder or precoding matrix based on the high-resolution PMI 1090 from the UEs. If operating in the SU-MIMO access scheme, the first performance prediction unit 1020 predicts a performance based on the generated precoder matrix and the CQI 1093.

Also, the first MU-MIMO precoder generation unit 1030 generates a precoder or precoding matrix based on the low-resolution index vector 1091. If operating in the SU-MIMO access scheme, the second performance prediction unit 1040 predicts a performance based on the generated precoder matrix and the CQI 1093.

The first and second performance prediction units 1020 and 1040 compare performances of the precoder matrices, and determine whether the operation is switched from the SU-MIMO access scheme to the MU-MIMO access scheme in operation 1094. If determining that the SU-MIMO access scheme is maintained based on the result of the comparison by the first and second performance prediction units 1020 and 1040, the first and second performance prediction units 1020 and 1040 provide the precoder matrix \textcircled{1}, i.e., a high-resolution SU-MIMO precoder matrix, which has been generated by the first SU-MIMO precoder generation unit 1010, to a precoder. On the other hand, if determining that the current SU-MIMO access scheme is switched to the MU-MIMO access scheme based on the result of the comparison by the first and second performance prediction units 1020 and 1040, the first and second performance prediction units 1020 and 1040 provide the precoder matrix \textcircled{2}, i.e., a low-resolution MU-MIMO precoder matrix, which has been generated by the first MU-MIMO precoder generation unit 1030, to a precoder.

If operating in the MU-MIMO access scheme in the wireless communication system for dynamically switching the SU/MU-MIMO access schemes, the apparatus 1000 to switch the SU/MU-MIMO access schemes according to an exemplary embodiment receives a low-resolution PMI 1096 and a CQI 1093, which are used to determine whether switching to the SU-MIMO access scheme is performed and are fed back, along with a high-resolution index vector 1095 from the UEs as described above.

The second MU-MIMO precoder generation unit 1070 generates a precoder or precoding matrix based on the high-resolution index vector 1095 and the CQI 1093. If operating in the MU-MIMO access scheme, the fourth performance prediction unit 1080 predicts a performance according to the generated precoder matrix based on the low-resolution PMI 1096 and the CQI 1093.

The second SU-MIMO precoder generation unit 1050 generates a precoder or precoding matrix based on the low-resolution PMI 1096 from the UEs. If operating in the MU-MIMO access scheme, the third performance prediction unit 1060 predicts a performance based on the generated precoder matrix and the CQI 1093.

The third and fourth performance prediction units 1060 and 1080 compare performances of the precoder matrices, and determine whether the operation is switched from the MU-MIMO access scheme to the SU-MIMO access scheme in operation 1097. If determining that the MU-MIMO access scheme is maintained based on the result of the comparison by the third and fourth performance prediction units 1060 and 1080, the third and fourth performance prediction units 1060 and 1080 provide the precoder matrix \textcircled{4}, i.e., a high-resolution MU-MIMO precoder matrix, which has been generated by the second MU-MIMO precoder generation unit 1070, to a precoder. On the other hand, if determining that the current MU-MIMO access scheme is switched to the SU-MIMO access scheme based on the result of the comparison by the third and fourth performance prediction units 1060 and 1080, the third and fourth performance prediction units 1060 and 1080 provide the precoder matrix \textcircled{3}, i.e., a low-resolution SU-MIMO precoder matrix, which has been generated by the second SU-MIMO precoder generation unit 1050, to a precoder.

At this time, a UE, which operates in the MU-MIMO access scheme, feeds back the high-resolution index vector 1095 in response to the MU-MIMO access scheme in which the UE currently operates. Then, the high-resolution index vector 1095, which has been fed back as described above, is input to the second MU-MIMO precoder generation unit 1070. On the other hand, the UE feeds back the low-resolution PMI 1096 in response to the SU-MIMO access scheme in which the UE does not currently operate. Then, the low-resolution PMI 1096, which has been fed back as described above, is input to the second SU-MIMO precoder generation unit 1050. The high-resolution index vector 1095 and the low-resolution PMI 1096 may be fed back simultaneously or at different times. Thereafter, if the UE needs to switch from the MU-MIMO access scheme to the SU-MIMO access scheme, the BS determines a precoder with reference to the low-resolution PMI which has been fed back for an SU-MIMO operation. In this regard, a more detailed description will be made hereinafter.

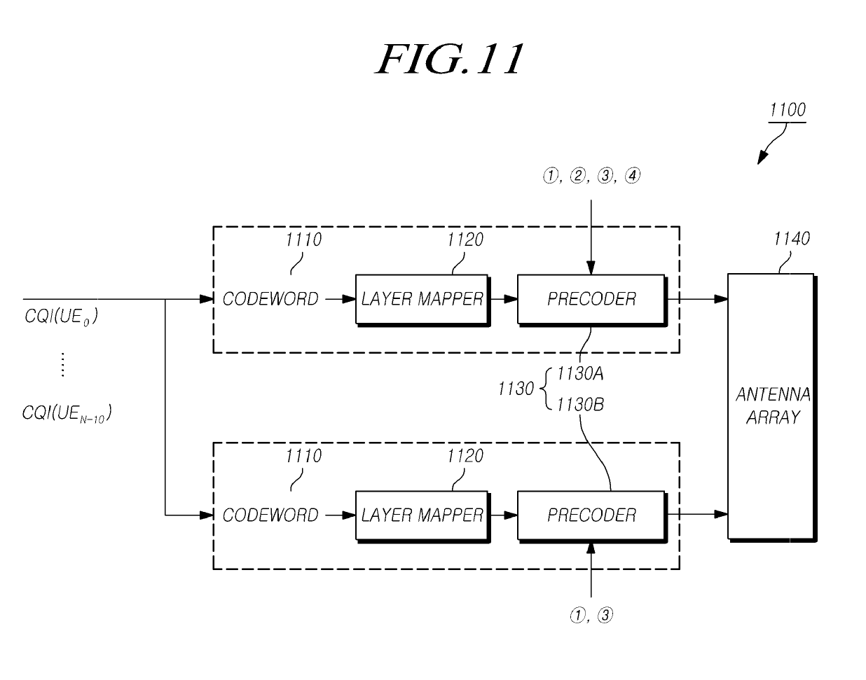

FIG. 11 is a block diagram illustrating a BS according to an exemplary embodiment of the present invention.

Referring to FIG. 11, a BS or BS apparatus 1100 includes a layer mapper 1120 to map a codeword to a layer; a precoder 1130 to precode mapped symbols by using a precoding matrix; and an antenna array 1140 having at least two antennas to propagate or transmit the precoded symbols into the air. Also, a selection, which is made of the number of ranks and the number of layers based on the received CQIs and PMIs that UEs have reported, is substantially similar to as described above with reference to FIG. 6. Therefore, a detailed description will be omitted.

Particularly, precoder matrices input to at least two precoders 1130A and 1130B are the same as described above with reference to FIG. 10.

If the apparatus 1000 to switch the SU/MU-MIMO access schemes operates in the SU-MIMO access scheme in the wireless communication system for dynamically switching the SU/MU-MIMO access schemes, the first and second performance prediction units 1020 and 1040 compare performances of the precoder matrices, as described above. If the first and second performance prediction units 1020 and 1040 determine that the SU-MIMO access scheme is maintained based on the result of the comparison, a particular precoder 1130B receives the precoder matrix \textcircled{1}, which has been generated by the first SU-MIMO precoder generation unit 1010, and precodes symbols. On the other hand, if the apparatus 1000 for switching the SU/MU-MIMO access schemes operates in the SU-MIMO access scheme, the first and second performance prediction units 1020 and 1040 compare performances of the precoder matrices. If the first and second performance prediction units 1020 and 1040 determine that the current SU-MIMO access scheme is switched to the MU-MIMO access scheme based on the result of the comparison, the at least two precoders 1130A and 1130B receive the precoder matrices \textcircled{1} and \textcircled{2}, which have been generated by the first SU-MIMO precoder generation unit 1010 and the first MU-MIMO precoder generation unit 1030, and precode symbols.

If the apparatus 1000 to switch the SU/MU-MIMO access schemes operates in the MU-MIMO access scheme, the third and fourth performance prediction units 1060 and 1080 compare performances of the precoder matrices, as described above. If the third and fourth performance prediction units 1060 and 1080 determine that the MU-MIMO access scheme is maintained based on the result of the comparison by them, the precoders 1130A and 1130B receive the precoder matrices \textcircled{3} and \textcircled{4}, which have been generated by the second SU-MIMO precoder generation unit 1050 and the second MU-MIMO precoder generation unit 1070, and precode symbols.

If the third and fourth performance prediction units 1060 and 1080 determine that the current MU-MIMO access scheme is switched to the SU-MIMO access scheme, the particular precoder 1130B receives the precoder matrix \textcircled{3}, which has been generated by the second SU-MIMO precoder generation unit 1050, and precodes symbols.

In a wireless communication system, a BS may perform a communication method which includes a layer mapping operation to map a codeword to a layer; a precoding operation to precode mapped symbols by using a precoding matrix generated based on one of high-resolution channel information and low-resolution channel information which have been fed back from each UE; and a transmission operation to propagate or transmit the precoded symbols into the air. Although the above description of the exemplary embodiments of the present invention is based on the accompanying drawings, aspects of the present invention are not limited thereto.

The embodiments as described above can be applied to uplink/downlink MIMO systems, and can be applied to not only a single cell environment but also all uplink/downlink MIMO systems which include a CoMP (Cooperative Multi-Point Transmission/Reception System), a heterogeneous network, and the like. In the embodiments as described above, a communication environment in which a UE dynamically switches SU/MU-MIMO access schemes is described as an example of the communication environment for a UE to feed back at least one of high resolution channel information and low resolution channel information to a BS. However, the UE can feed back at least one of high resolution channel information and low resolution channel information to the BS in any environment. For example, the UE may feed back low resolution channel information to the BS in the case of attempting to reduce the overhead of the feedback at the expense of the exactness of the channel information. In contrast, the UE may feed back high resolution channel information to the BS in the case of attempting to improve the exactness of the channel information in spite of the overhead of the feedback.

Although only the high resolution CQI and low resolution CQI are discussed, aspects are not limited thereto such that the channel information may have various resolutions. For example, the resolutions of the channel information may be classified into three levels including high, middle, and low levels.

Even if it was described above that all of the components of an exemplary embodiment of the present invention are coupled as a single unit or coupled to be operated as a single unit, aspects of the present invention are not limited thereto. That is, among the components, one or more components may be selectively coupled to be operated as one or more units. In addition, although each of the components may be implemented as an independent hardware, some or all of the components may be selectively combined with each other, so that they can be implemented as a computer program having one or more program modules to execute some or all of the functions combined in one or more hardwares. Codes and code segments forming the computer program may be easily conceived by an ordinarily skilled person in the technical field of the present invention. Such a computer program may implement the exemplary embodiments of the present invention by being stored in a computer readable storage medium, and being read and executed by a computer. A magnetic recording medium, an optical recording medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to feed back channel information in a wireless communication system, the apparatus comprising:
a reference signal reception unit to receive a reference signal from a base station;
a channel estimator to perform channel estimation by using the received reference signal;
a precoder search unit to generate at least one type of channel information from among high resolution channel information and low resolution channel information based on a result of the channel estimation by the channel estimator; and
a feedback unit to feed back the channel information,
wherein the high resolution channel information corresponds to channel information having a large quantity of feedback information and the low resolution channel information corresponds to channel information having a small quantity of feedback information.

2. The apparatus of claim 1, wherein the channel information comprises a Precoding Matrix Index (PMI) indicating a precoding matrix.

3. The apparatus of claim 2, wherein the high resolution channel information is a PMI selected from all PMIs of a precoder codebook and the low resolution channel information is a PMI selected from a part of the PMIs of the precoder codebook.

4. The apparatus of claim 1, wherein the high resolution channel information refers to a high resolution PMI (Precoding Matrix Index) and the low resolution channel information refers to a low resolution PMI (Precoding Matrix Index), and the high resolution PMI (Precoding Matrix Index) has a larger quantity of information than the low resolution PMI (Precoding Matrix Index).

5. A method for feeding back channel information in a wireless communication system, the method comprising:
receiving a reference signal from a base station;
performing channel estimation by using the received reference signal;
generating at least one type of channel information from among high resolution channel information and low resolution channel information based on a result of the channel estimation; and
feeding back the channel information,
wherein the high resolution channel information corresponds to channel information having a large quantity of feedback information and the low resolution channel information corresponds to channel information having a small quantity of feedback information.

6. The method of claim 5, wherein the channel information comprises a Precoding Matrix Index (PMI) indicating a precoding matrix.

7. The method of claim 6, wherein the high resolution channel information is a PMI selected from all PMIs of a precoder codebook and the low resolution channel information is a PMI selected from a part of the PMIs of the precoder codebook.

8. The method of claim 5, wherein the high resolution channel information refers to a high resolution PMI (Precoding Matrix Index) and the low resolution channel information refers to a low resolution PMI (Precoding Matrix Index), and the high resolution PMI (Precoding Matrix Index) has a larger quantity of information than the low resolution PMI (Precoding Matrix Index).

9. A base station of a wireless communication system, the base station comprising:
a layer mapper to map a codeword to a layer;
a precoder to precode mapped symbols by using a precoding matrix generated based on one of high resolution channel information and low resolution channel information fed back from a User Equipment (UE); and
an antenna array including at least two antennas to transmit the precoded symbols,
wherein the high resolution channel information corresponds to channel information having a large quantity of feedback information and the low resolution channel information corresponds to channel information having a small quantity of feedback information.

10. The base station of claim 9, wherein the channel information comprises a Precoding Matrix Index (PMI) indicating a precoding matrix.

11. The base station of claim 10, wherein the high resolution channel information is a PMI selected from all PMIs of a precoder codebook and the low resolution channel information is a PMI selected from a part of the PMIs of the precoder codebook.

12. The base station of claim 9, wherein the high resolution channel information refers to a high resolution PMI (Precoding Matrix Index) and the low resolution channel information refers to a low resolution PMI (Precoding Matrix Index), and the high resolution PMI (Precoding Matrix Index) has a larger quantity of information than the low resolution PMI (Precoding Matrix Index).

13. A method for a base station in a wireless communication system, the method comprising:
mapping a codeword to a layer;
precoding mapped symbols by using a precoding matrix generated based on one of high resolution channel information and low resolution channel information fed back from a User Equipment (UE); and
transmitting the precoded symbols,
wherein the high resolution channel information corresponds to channel information having a large quantity of feedback information and the low resolution channel information corresponds to channel information having a small quantity of feedback information.

14. The method of claim 13, wherein the channel information comprises a Precoding Matrix Index (PMI) indicating a precoding matrix.

15. The method of claim 14, wherein the high resolution channel information is a PMI selected from all PMIs of a precoder codebook and the low resolution channel information is a PMI selected from a part of the PMIs of the precoder codebook.

16. The method of claim 13, wherein the high resolution channel information refers to a high resolution PMI (Precoding Matrix Index) and the low resolution channel information refers to a low resolution PMI (Precoding Matrix Index), and the high resolution PMI (Precoding Matrix Index) has a larger quantity of information than the low resolution PMI (Precoding Matrix Index).
